(19) United States
(12) Patent Application Publication
(10) Pub. No.: US 2007/0032913 A1
(43) Pub. Date: Feb. 8, 2007

(54) Method and system for dynamic automotive vehicle moding

(76) Inventors: Youssef A. Ghoneim, Torslanda (SE); Robert R. Bolio, Clarkston, MI (US); Matthew M. Karaba, Oxford, MI (US); Robert W. Leschuk, Oxford, MI (US); Michael P. Turski, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/197,094

(22) Filed: Aug. 4, 2005

(51) Int. Cl. G05D 1/00

(52) U.S. Cl. 701/1

(57) ABSTRACT

Methods and systems are provided for controlling vehicle moding in response to a variety of driving conditions. The system comprises an input device configured to receive first and second inputs, a vehicle subsystem, and a controller coupled to each of the vehicle subsystem and the input device. The vehicle subsystem is configured to produce a parameter related to the driving condition in the first mode. The controller is configured to determine the driving condition from the parameter, control the vehicle subsystem to operate in a first mode based on the first input, and control the vehicle subsystem to operate in a second mode in response to one of the driving condition and the second input. The method comprises determining the driving condition during operation of a vehicle subsystem, operate the vehicle subsystem in a first mode upon receiving a first input indicating an acceptance of the first mode, and operate the vehicle subsystem in a second mode based on one of receiving a second input and the driving condition. The second input indicates a non-acceptance of the first mode.

### TECHNICAL FIELD

The present invention generally relates to coordination of vehicle control systems, and more particularly relates to methods for selecting vehicle subsystem modes in response to a variety of driving conditions and systems for controlling vehicle subsystem moding in response to a variety of driving conditions.

### BACKGROUND OF THE INVENTION

Modern vehicles incorporate a variety of active vehicle control subsystems (e.g., an anti-lock brake system, a traction control system, etc.) that enhance comfort, safety, and the overall driving experience. In some instances, such vehicle control subsystems are calibrated to one setting regardless of a particular driving condition. In other cases, different driver selectable modes have been developed that allow modification of different subsystem behaviors based on a driver preference and a vehicle operating condition. For example, a driver may select a sport mode that alters a suspension subsystem from a predetermined normal setting to a predetermined stiffer setting so as to provide a more responsive vehicle.

Although these driver selectable modes may alter the various vehicle control subsystems from one predetermined setting to another predetermined setting, the vehicle may encounter any variety and combinations of driving conditions. The predetermined setting is typically activated upon a driver selection such that the driver determines whether the predetermined setting is appropriate for the driving condition. Even after selection of the predetermined setting by the driver, the predetermined setting may be less than desirable for the driving condition.

Accordingly, it is desirable to provide a system for detecting a driving condition and controlling selection of vehicle subsystem modes in response to the driving condition. More particularly, it is desirable to provide a system for controlling vehicle subsystem moding that autonomously selects an operation mode of the vehicle subsystem for a driving condition and implements the operation mode upon receiving a confirmation. Additionally, it is desirable to provide a method for controlling vehicle subsystem moding that autonomously selects an operation mode of the vehicle subsystem for a driving condition and implements the operation mode upon receiving a confirmation. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

Methods and systems are provided for controlling vehicle moding in response to a driving condition. The system comprises an input device configured to receive first and second inputs, a vehicle subsystem, and a controller coupled to the vehicle subsystem and the input device. The vehicle subsystem is configured to produce a parameter related to the driving condition. The controller is configured to determine the driving condition from the parameter, control the vehicle subsystem to operate in a first mode based on the first input, and control the vehicle subsystem to operate in a second mode in response to one of the driving condition and the second input.

The method comprises determining the driving condition during operation of a vehicle subsystem, operating the vehicle subsystem in a first mode upon receiving a first input indicating an acceptance of the first mode, and operating the vehicle subsystem in a second mode based on one of receiving a second input and the driving condition. The second input indicates a non-acceptance of the first mode.

A control system is also provided for selecting an operation mode of a vehicle in response to a driving condition. The control system comprises an input device configured to receive first and second inputs, a vehicle subsystem comprising at least two predetermined settings, and a controller coupled to the vehicle subsystem and the input device. The first input indicates an acceptance of the operation mode, and the second input indicates a non-acceptance of the operation mode. The controller is configured to determine the driving condition, change the vehicle subsystem to a first predetermined setting upon receiving the first input, and change the vehicle subsystem to a second predetermined setting based at least in part upon receiving the second input and the driving condition.

### DESCRIPTION OF THE DRAWINGS

The present invention will hereinafter be described in conjunction with the following drawing figures, wherein like numerals denote like elements, and

FIG. 1 is a schematic diagram of a vehicle moding control system in accordance with an exemplary embodiment of the present invention;

FIG. 2 is flow chart of a method for controlling vehicle moding in response to a driving condition in accordance with an exemplary embodiment of the present invention;

FIG. 3 is a flow chart of vehicle moding in response to a rain/snow condition in accordance with an exemplary embodiment;

FIG. 4 is a flow chart of vehicle moding in response to a tow/haul condition in accordance with an exemplary embodiment;

FIG. 5 is a flow chart of vehicle moding in response to a low-tire pressure/mini-spare condition in accordance with an exemplary embodiment;

FIG. 6 is a flow chart of a vehicle moding in response to a phone-in-use/multimedia-in-use condition in accordance with an exemplary embodiment;

FIG. 7 is a flow chart of a vehicle moding in response to a nighttime condition in accordance with an exemplary embodiment;

FIG. 8 is a flow chart of a vehicle moding in response to an off-road condition in accordance with an exemplary embodiment; and

FIG. 9 is a flow chart of a vehicle moding in response to a racetrack condition in accordance with an exemplary embodiment.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

A system and method are provided for controlling vehicle moding in response to various driving conditions. In general, the system comprises an input device configured to receive first and second inputs, a vehicle subsystem, and a controller coupled to each of the vehicle subsystem and the input device. The vehicle subsystem is configured to produce a parameter related to the driving condition. The controller is configured to determine the driving condition from the parameter, control the vehicle subsystem to operate in a first mode based on the first input, and control the vehicle subsystem to operate in a second mode in response to one of the driving condition and the second input.

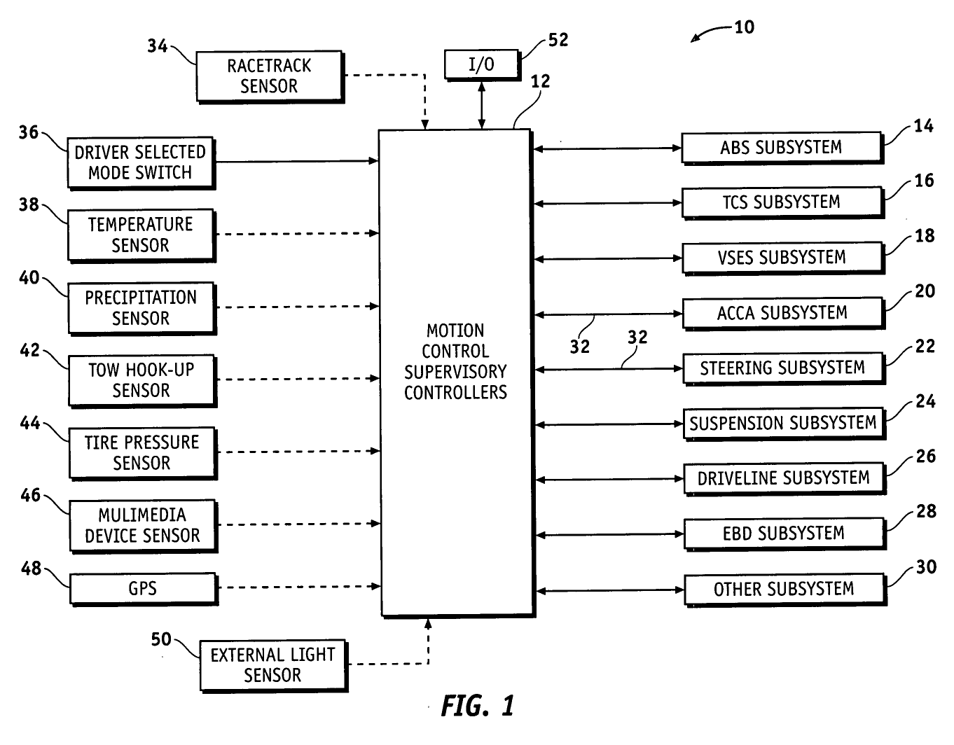

Referring to FIG. 1, a schematic diagram of a vehicle moding control system 10 is provided in accordance with an exemplary embodiment of the present invention. The vehicle moding control system 10 controls a variety of control subsystems in a vehicle and comprises a motion control supervisory controller 12 that is coupled to: an Anti-lock Braking Subsystem 14 (ABS), a Traction Control Subsystem 16 (TCS), a Vehicle Stability Enhancement Subsystem 18 (VSES), an Adaptive Cruise Control (ACC) subsystem 20, a steering subsystem 22, a suspension subsystem 24, a driveline subsystem 26, an Electronic Brake force Distribution (EBD) subsystem 28, a driver selected mode switch 36, and an Input/Output (I/O) device 52 (e.g., a display, a touch-screen, audio transceiver, or the like). Other vehicle control subsystems may also be coupled to the motion control supervisory controller 12. The motion control supervisory controller 12 is coupled to the various vehicle subsystems, the driver selected mode switch 36, and the I/O device 52 via a vehicle communications network 32.

The motion control supervisory controller 12 and the vehicle subsystems include, but is not necessarily limited to, a processing unit that controls the operation of the particular vehicle subsystem. For example, the VSES 18 may have a processing unit that selects a predetermined operation mode or setting of the VSES 18, and this processing unit may operate under control from the motion control supervisory controller 12 or in accordance with a driver selected mode as subsequently described in greater detail. The processing unit for the motion control supervisory controller 12 resides in a separate module from the other vehicle subsystems or, alternatively, is integrated with the module for one of the vehicle subsystems while remaining separated from the processing unit for such vehicle subsystem.

Some of the vehicle subsystems have predetermined settings for different adaptive modes as subsequently described in greater detail. The processing unit of a particular vehicle subsystem selects one of the predetermined settings upon instruction from the motion control supervisory controller 12. The TCS 16 includes a TCS normal setting, a TCS sport setting, a TCS comfort setting, and a TCS tow/haul setting. The steering subsystem 22 includes a steering tow/haul setting, a steering normal setting, a steering sport setting, a steering comfort setting, and a steering off-road setting. The ABS 14 includes an ABS normal setting and an ABS off-road setting. The driveline subsystem 26 includes a driveline normal setting, a driveline sport setting, a driveline comfort setting, and a driveline disable setting. The EBD subsystem 28 includes an EBD normal setting and an EBD sport setting. The ACC subsystem 20 includes an ACC normal setting and an ACC comfort setting. The VSES 18 includes a VSES tow/haul setting, a VSES normal setting, a VSES sport setting, a VSES comfort setting, and a VSES off-road setting. The suspension subsystem 24 includes a suspension off-road setting, a suspension normal setting, a suspension sport setting, a suspension comfort setting, and a suspension-tow/haul setting. Each of these vehicle subsystems may include other predetermined settings, and other vehicle subsystems may also have predetermined settings.

In addition to the processing unit, the motion control supervisory controller 12 further includes, but is not necessarily limited to, a memory having a look-up data table that is accessed by the processing unit of the motion control supervisory controller 12 to determine a current driving condition. The motion control supervisory controller 12 receives and monitors a variety of parameters from one or more of the various vehicle subsystems. Each of the parameters is related to a particular operation associated with a vehicle subsystem. For example, the ACC subsystem 20 may obtain a vehicle velocity parameter, among other parameters, for operating the adaptive cruise control function. In an exemplary embodiment, the motion control supervisory controller 12 determines the current driving condition encountered by the vehicle by comparing the relevant parameters with data (e.g., thresholds or operating ranges) stored in the look-up data table.

Although the motion control supervisory controller 12 retrieves various driving condition parameters from the vehicle subsystems, any variety and number of sensors may optionally be coupled with the motion control supervisory controller 12 to provide driving condition parameters. For example, the vehicle moding control system 10 may further comprise an ambient temperature sensor 38 coupled to the motion control supervisory controller 12, a precipitation sensor 40 coupled to the motion control supervisory controller 12, a tow hook-up sensor 42 coupled to the motion control supervisory controller 12, a tire pressure sensor 44 coupled to the motion control supervisory controller 12, a multimedia device sensor 46 coupled to the motion control supervisory controller 12, a Global Positioning System (GPS) transponder 48 coupled to the motion control supervisory controller 12, an external light sensor 50 coupled to the motion control supervisory controller 12, and a racetrack sensor 34 coupled to the motion control supervisory controller 12. In this example, the motion control supervisory controller 12 receives the relevant parameters directly from one or more of these sensors and the GPS transponder 48 (e.g., precipitation detected by the precipitation sensor 40).

Based on the driving condition determined by the motion control supervisory controller 12, the motion control supervisory controller 12 selects a vehicle operation mode or an adaptive mode that corresponds to the driving condition (e.g., a tow/haul mode when a tow hook-up is detected). The motion control supervisory controller 12 indicates the driving condition and recommends the adaptive mode to a vehicle operator via the I/O device 52. Upon receiving a first signal, such as via the I/O device 52, indicating an acceptance of the recommended vehicle operation mode by the vehicle operator, the motion control supervisory controller 12 implements the adaptive mode by controlling one or more vehicle subsystems to operate in a first predetermined setting corresponding to the adaptive mode. Upon receiving a second signal indicating a non-acceptance of the recommended vehicle operation mode by the vehicle operator, the motion control supervisory controller 12 controls one or more vehicle subsystems to operate in accordance with a driver selected mode or in a second predetermined setting. The motion control supervisory controller 12 may autonomously control one or more predetermined vehicle subsystems to operate in the second predetermined setting. Alternatively, depending on the particular driving condition, the motion control supervisory controller 12 autonomously implements an adaptive mode corresponding to a predetermined driving condition without notification or prompting for vehicle operator acceptance.

Prior to the motion control supervisory controller 12 selecting a vehicle operation mode corresponding to the driving condition, one or more of the vehicle subsystems may be operating under a driver selected mode. For example, the suspension subsystem 24 may be operating in an off-road mode as selected by the vehicle operator. Examples of driver selectable modes include, but are not necessarily limited to, a normal driving mode, a comfort mode, a sport/competition mode, an off-road mode, and a tow/haul mode. The normal driving mode is referred to herein as a default driving mode in which all vehicle subsystems are calibrated for a predetermined normal customer usage.

The comfort mode is referred to herein as a driving mode with the relevant vehicle subsystems calibrated to a predetermined setting to generally provide a more comfortable ride. Examples of some vehicle subsystem changes when selecting the comfort mode include, but are not necessarily limited to, reducing slip targets in the TCS 16, reducing deadband entrance criteria and increasing control gains of the VSES 18, lowering steering sensitivity and increasing the linear range stability of the steering subsystem 22 throughout the entire vehicle speed range, calibrating the ACC subsystem 20 to increase following distance for all speed ranges above a predetermined lower threshold, maximizing intervention capability of the driveline subsystem 26, optimizing shift points of the transmission controls, modifying engine controls for optimal fuel consumption, and adjusting throttle progression for greater launch comfort.

The sport/competition mode is referred to herein as a driving mode with the relevant vehicle subsystems calibrated to a predetermined setting for a more performance response from the vehicle. Examples of some vehicle subsystem changes when selecting the sport/competition mode include, but are not necessarily limited to, increasing slip targets of the TCS 16, allowing for more rear-biased straight line braking in the EBD subsystem 28, increasing deadband entrance criteria and decreasing control gains of the VSES 18, providing a more direct and responsive steering via the steering subsystem 22, modifying the suspension subsystem 24 to provide a sport tuned damper and stabilizer bar settings for flatter vehicle cornering, accentuating rear wheel drive bias in the driveline subsystem 26, and modifying the transmission controls to maximize power delivery.

The off-road mode is referred to herein as a driving mode with the relevant vehicle subsystems calibrated to a predetermined setting for maneuverability, performance, and ease of travel in a variety of off-road conditions. Examples of some vehicle subsystem changes when selecting the off-road mode include, but are not necessarily limited to, increasing slip targets of the TCS 16 to allow the vehicle to move more readily on deformable surfaces and lowering slip targets for rock crawling, removing P/T control from the VSES 18 at lower speeds while maintaining brake based gains and control and ramping in P/T control for increased speeds, optimizing the steering subsystem 22 for low speed maneuverability when vehicle is in a low gear range, softening damping and ARC of the suspension subsystem 24 to allow more vehicle roll and wheel articulation, disabling the ACC subsystem 20, locking the differentials of the driveline subsystem 26, and raising the minimum vehicle speed for activation of the ABS 14.

The tow/haul mode is referred to herein as a driving mode with the relevant vehicle subsystems calibrated to a predetermined setting for trailering. Examples of some vehicle subsystem changes when selecting the tow/haul mode include, but are not necessarily limited to, applying a comfort setting to the VSES 18 with trailer stabilization logic, optimizing the steering subsystem 22 for trailering, increasing damping control of the suspension subsystem 24, and optimizing the shift schedule of the transmission control.

When responding to a driving condition, the motion control supervisory controller 12 may modify some or all of the predetermined settings for a particular driver selected mode to implement one or more adaptive modes. Examples of the adaptive modes include, but are not necessarily limited to, a rain/snow detected mode, a tow/haul detected mode, a low-tire pressure/mini-spare detected mode, a phone-in-use/multimedia-in-use detected mode, a nighttime detected mode, an off-road detected mode, and a racetrack detected mode. Selection and implementation of a particular adaptive mode is based on vehicle, environment, and driver operating conditions. As previously mentioned hereinabove, in some cases the motion control supervisory controller 12 autonomously changes the relevant vehicle subsystems to implement an adaptive mode, and in other cases the motion control supervisory controller 12 requests driver acceptance prior to implementing an adaptive mode.

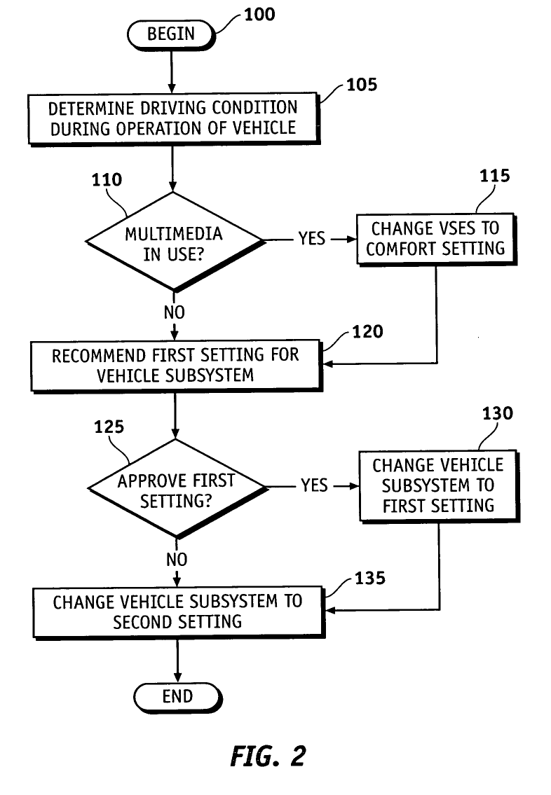

Referring to FIGS. 1 and 2, a flow chart is shown of a method for controlling vehicle moding in response to a driving condition in accordance with an exemplary embodiment of the present invention. The method begins at 100. The motion control supervisory controller 12 determines a driving condition from parameters received from the various vehicle subsystems or sensors during operation of the vehicle at 105. The motion control supervisory controller 12 may also display the detected driving condition to the vehicle operator via the I/O device 52. The motion control supervisory controller 12 determines if the driving condition is a phone-in-use/multimedia-in-use condition at step 110, such as via the multimedia device sensor 46. In the event that the driving condition is a phone-in-use/multimedia-in-use, the motion control supervisory controller 12 autonomously implements the phone-in-use/multimedia-in-use mode by changing the VSES 18 to the VSES comfort setting at step 115. In the event that the driving condition is not a phone-in-use/multimedia-in-use condition, the motion control supervisory controller 12 recommends an adaptive mode for the detected driving condition by displaying the adaptive mode on the I/O device 52 at step 120. The motion control supervisory controller 12 requests acceptance of the recommended adaptive mode from the vehicle operator at step 125. In the event that the adaptive mode is accepted, the motion control supervisory controller 12 changes one or more relevant vehicle subsystems to a first predetermined setting based on the recommended adaptive mode at step 130. In the event that the adaptive mode is rejected, the motion control supervisory controller 12 changes one or more relevant vehicle subsystems to a second predetermined setting at step 135.

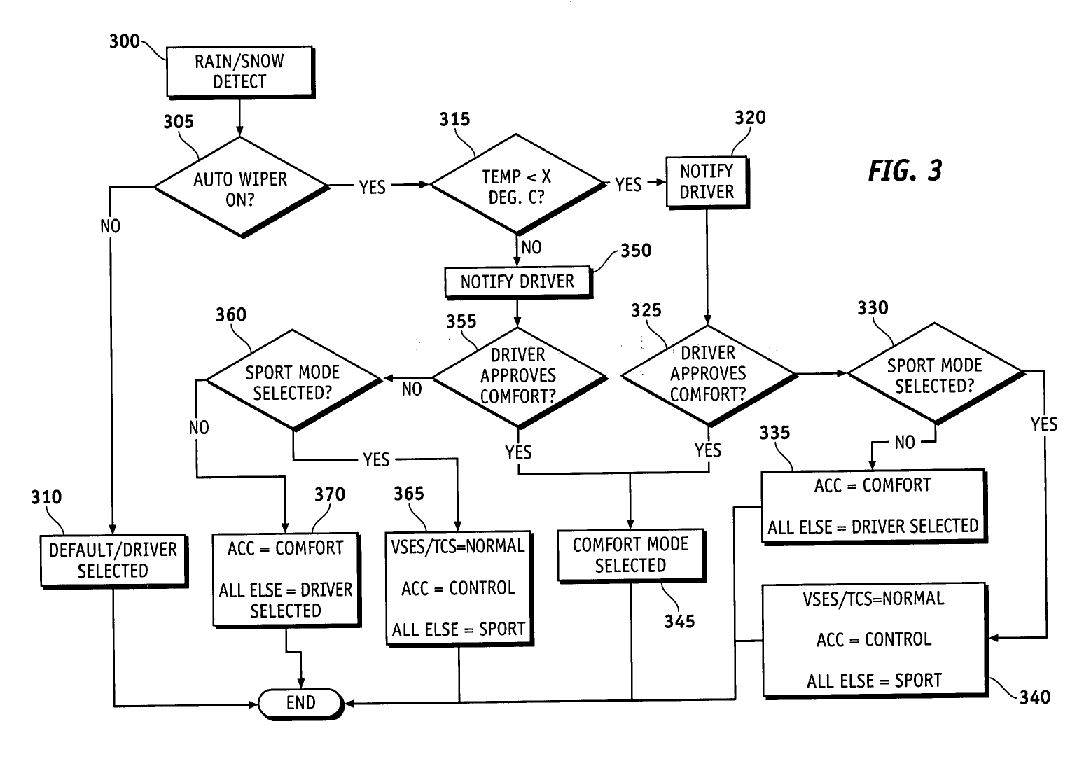

Referring to FIGS. 1 and 3, a flow chart is shown of vehicle moding in response to a rain/snow condition in accordance with an exemplary embodiment. The rain/snow vehicle mode begins at step 300. The motion control supervisory controller 12 determines whether an automatic windshield wiper function is activated at step 305, such as via the precipitation sensor 40 or via communication with a windshield wiper controller. When the automatic windshield wiper function is not activated, the motion control supervisory controller 12 allows the vehicle subsystems to continue operating in a default setting or any driver selected mode at step 310. When the automatic windshield wiper function is activated, the motion control supervisory controller 12 determines whether the ambient temperature outside of the vehicle is lower than a predetermined threshold temperature (e.g., a freezing point for precipitation) at step 315, such as via the temperature sensor 38.

When the ambient temperature is determined to be lower than the threshold temperature, the motion control supervisory controller 12 indicates a snow condition, such as via the I/O device 52, at step 320, and requests an acceptance of a snow mode at step 325. When the snow mode is rejected, the motion control supervisory controller 12 determines whether a sport mode has been selected at step 330. When the sport mode has been selected, such as via the driver selected mode switch 36, the motion control supervisory controller 12 changes the VSES 18 and TCS 16 to the normal setting, the ACC subsystem 20 to the comfort setting, and all other vehicle subsystems to the sport setting at step 340. When the sport mode has not been selected, the motion control supervisory controller 12 changes the ACC subsystem 20 to the comfort setting and all other vehicle subsystems to the setting corresponding to the driver selected mode. When the snow mode is accepted, the motion control supervisory controller 12 changes the vehicle subsystems to the comfort setting at step 345.

When the ambient temperature is determined to be higher than the threshold temperature, the motion control supervisory controller 12 indicates a rain condition, such as via the I/O device 52, at step 350, and requests an acceptance of a rain mode at step 355. When the rain mode is accepted, the motion control supervisory controller 12 changes the vehicle subsystems to the comfort setting at step 345. When the rain mode is rejected, the motion control supervisory controller 12 determines whether the sport mode has been selected at step 360. When the sport mode has been selected, the motion control supervisory controller 12 changes the VSES 18 and the TCS 16 to the normal setting, the ACC subsystem 20 to the comfort setting, and all other vehicle subsystems to the sport setting. When the sport mode has not been selected, the motion control supervisory controller 12 changes the ACC subsystem 20 to the comfort setting and all other vehicle subsystems to the setting corresponding to the driver selected mode.

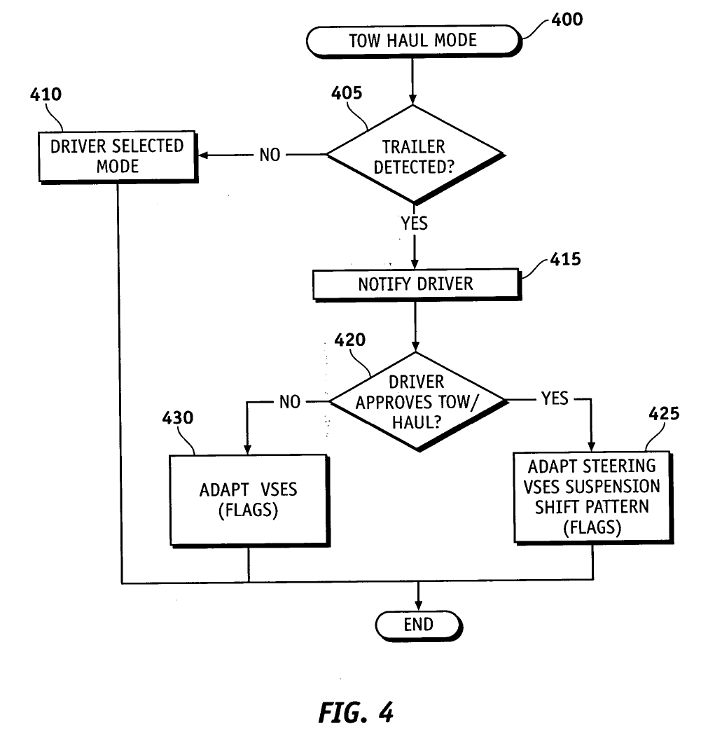

Referring to FIGS. 1 and 4, a flow chart is shown of vehicle moding in response to a tow/haul condition in accordance with an exemplary embodiment. The tow/haul vehicle mode begins at step 400. The motion control supervisory controller 12 determines whether a trailer connection is detected at step 405, such as via the tow hook-up sensor 42. When a trailer connection is not detected, the motion control supervisory controller 12 changes or maintains the vehicle subsystems in the driver selected mode at step 410. When a trailer connection is detected, the motion control supervisory controller 12 indicates a tow/haul condition at step 415, such as via the I/O device 52, and requests an acceptance of the tow/haul mode at step 420. When the tow/haul mode is accepted, the motion control supervisory controller 12 changes each of the steering subsystem 22, the VSES 18, the suspension subsystem 24, and the driveline subsystem 26 to the tow/haul setting at step 425. When the tow/haul mode is rejected, the motion control supervisory controller 12 changes the VSES 18 to the tow/haul setting at step 430.

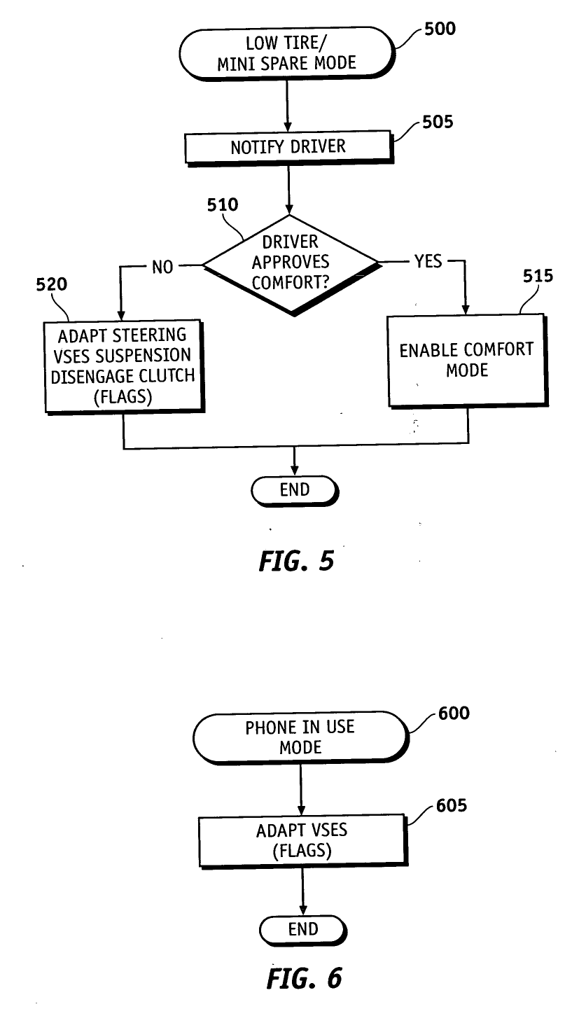

Referring to FIGS. 1 and 5, a flow chart is shown of vehicle moding in response to a low-tire pressure/mini-spare condition in accordance with an exemplary embodiment. The low-tire pressure/mini-spare mode begins at step 500. The low-tire pressure/mini-spare condition may be determined via the tire pressure sensor 44. The motion control supervisory controller 12 indicates the low-tire pressure/mini-spare condition at step 505, such as via the I/O device 52, and requests an acceptance of a low-tire pressure/mini-spare mode at step 510. When the low-tire pressure/mini-spare mode is accepted, the motion control supervisory controller 12 changes the vehicle subsystems to the comfort setting at step 515. When the low-tire pressure/mini-spare mode is rejected, the motion control supervisory controller 12 changes each of the steering subsystem 22, the VSES 18, the suspension subsystem 24 to the comfort setting and disables the clutch at step 520.

Referring to FIGS. 1 and 6, a flow chart is shown of a vehicle moding in response to a phone-in-use/multimedia-in-use condition in accordance with an exemplary embodiment. The phone-in-use/multimedia-in-use mode begins at step 600. As previously mentioned, the phone-in-use/multimedia-in-use condition may be determined via the multimedia device sensor 46. The motion control supervisory controller 12 changes the VSES 18 to the comfort setting at step 605.

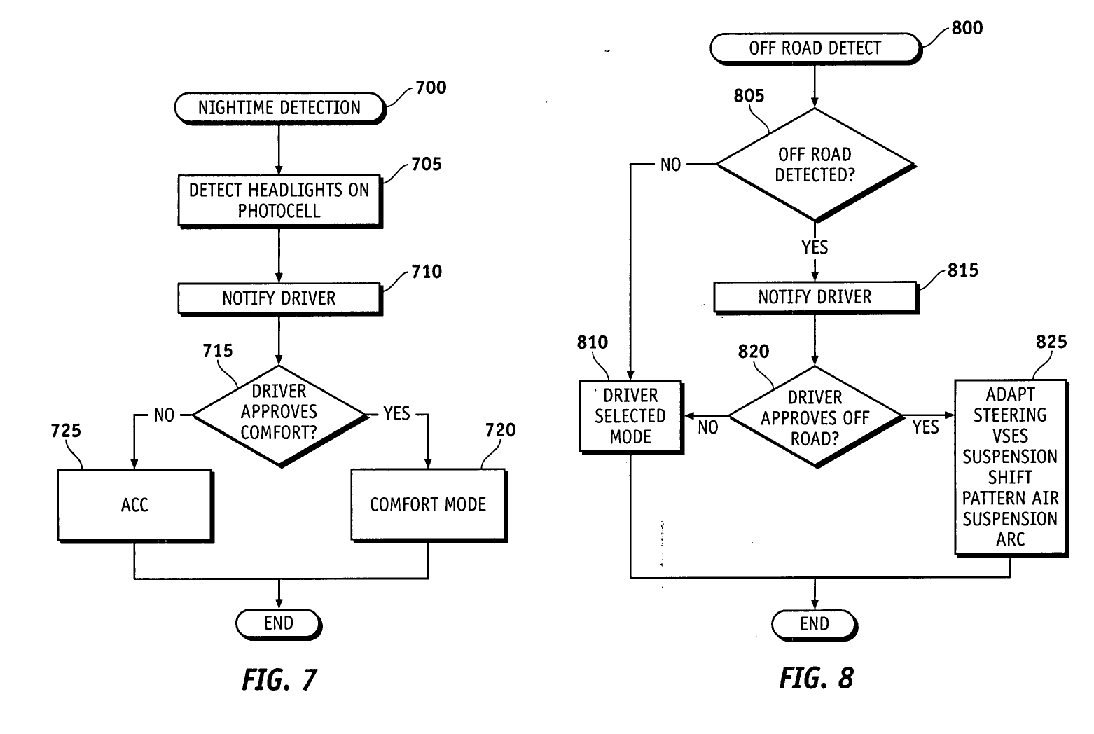

Referring to FIGS. 1 and 7, a flow chart is shown of a vehicle moding in response to a nighttime condition in accordance with an exemplary embodiment. The nighttime mode begins at step 700. The motion control supervisory controller 12 may determine the nighttime condition by detecting an activation of the headlights at step 705, such as via an external light sensor (e.g., a photocell). The motion control supervisory controller 12 indicates the nighttime condition at step 710, such as via the I/O device 52, and requests an acceptance of the nighttime mode at step 715. When the nighttime mode is accepted, the motion control supervisory controller 12 changes the vehicle subsystems to the comfort setting at step 720. When the nighttime mode is rejected, the motion control supervisory controller 12 changes the ACC subsystem 20 to the comfort setting.

Referring to FIGS. 1 and 8, a flow chart is shown of a vehicle moding in response to an off-road condition in accordance with an exemplary embodiment. The off-road mode begins at step 800. The motion control supervisory controller 12 determines whether the off-road condition is detected at step 805, such as via the GPS sensor 48. When the off-road condition is not detected, the motion control supervisory controller 12 changes or maintains the vehicle subsystems in the driver selected mode at step 810. When the off-road condition is detected, the motion control supervisory controller 12 indicates the off-road condition at step 815, such as via the I/O device 52, and requests an acceptance of the off-road mode at step 820. When the off-road mode is accepted, the motion control supervisory controller 12 changes each of the steering subsystem 22, the VSES 18, the suspension subsystem 24, and the driveline subsystem 26 to the off-road setting at step 825. When the off-road mode is rejected, the motion control supervisory controller 12 changes or maintains the vehicle subsystems in the driver selected mode at step 810.

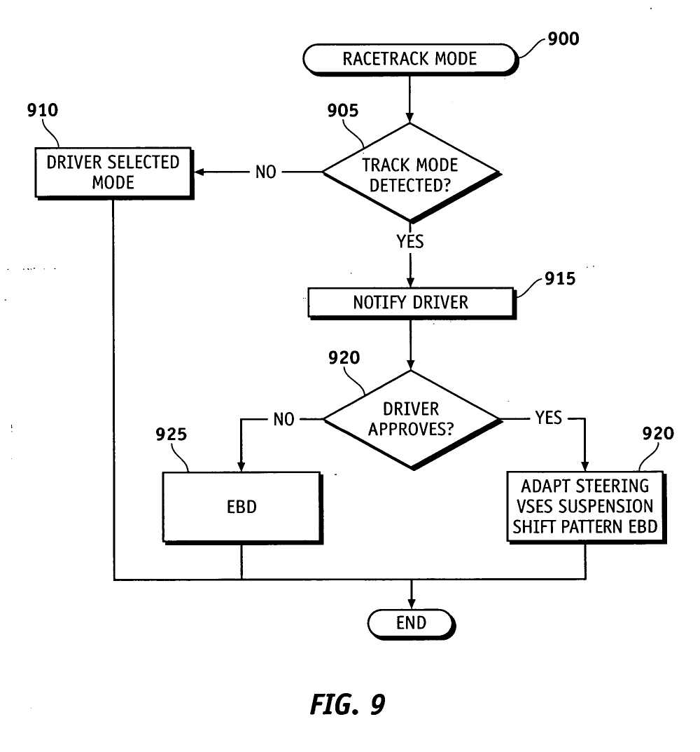

Referring to FIGS. 1 and 9, a flow chart is shown of a vehicle moding in response to a racetrack condition in accordance with an exemplary embodiment. The racetrack mode begins at step 900. The motion control supervisory controller 12 determines whether the racetrack condition is detected at step 905, such as via the racetrack sensor 34. When the racetrack condition is not detected, the motion control supervisory controller 12 changes or maintains the vehicle subsystems in the driver selected mode at step 910. When the racetrack condition is detected, the motion control supervisory controller 12 indicates the racetrack condition at step 915, such as via the I/O device 52, and requests an acceptance of the racetrack mode at step 920. When the racetrack mode is accepted, the motion control supervisory controller 12 changes each of the steering subsystem 22, the VSES 18, the suspension subsystem 24, the driveline subsystem 26, and the EBD subsystem 28 to the sport setting at step 925. When the racetrack mode is rejected, the motion control supervisory controller 12 changes the EBD subsystem 28 to the sport setting at step 810.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A system for controlling vehicle moding in response to a driving condition, the control system comprising:
an input device configured to receive first and second inputs;
a vehicle subsystem configured to produce a parameter related to the driving condition; and
a controller coupled to said vehicle subsystem and said input device and configured to:
determine the driving condition from said parameter;
control said vehicle subsystem to operate in a first mode based on said first input; and
control said vehicle subsystem to operate in a second mode in response to one of the driving condition and said second input.

2. A system for controlling vehicle moding according to claim 1, wherein said vehicle subsystem is selected from an anti-lock braking subsystem, a traction control subsystem, a vehicle stability enhancement subsystem, an adaptive cruise control subsystem, a steering subsystem, a suspension subsystem, a driveline subsystem, and an electronic brake force distribution subsystem.

3. A system for controlling vehicle moding according to claim 1, wherein said vehicle subsystem comprises a traction control subsystem, a vehicle stability enhancement subsystem, and an adaptive cruise control subsystem; and
wherein after said controller determines a rain/snow driving condition and after said controller receives said second input from said input device said controller is further configured to change said vehicle stability enhancement subsystem and said traction control subsystem to operate in said second mode.

4. A system for controlling vehicle moding according to claim 1, wherein said vehicle subsystem comprises a steering subsystem, a vehicle stability enhancement subsystem, a suspension subsystem, and a driveline subsystem; and
wherein after said controller determines a tow/haul driving condition and after said controller receives said second input from said input device said controller is further configured to change said vehicle stability enhancement subsystem to operate in said second mode.

5. A system for controlling vehicle moding according to claim 1, wherein said vehicle subsystem comprises a steering subsystem, a vehicle stability enhancement subsystem, a suspension subsystem, and a driveline subsystem; and
wherein after said controller determines a low-tire pressure/mini-spare driving condition and after said controller receives said second input from said input device said controller is further configured to change each of said steering subsystem, said vehicle stability enhancement subsystem, said suspension subsystem, and said driveline subsystem to said second mode.

6. A system for controlling vehicle moding according to claim 1, wherein said vehicle subsystem comprises a vehicle stability enhancement subsystem; and
wherein after said controller determines a phone-in-use/multimedia-in-use driving condition said controller is further configured to change said vehicle stability enhancement subsystem to said second mode.

7. A system for controlling vehicle moding according to claim 1, wherein said vehicle subsystem comprises an adaptive cruise control subsystem; and
wherein after said controller determines a nighttime driving condition and after said controller receives said second input from said input device said controller is further configured to change said adaptive cruise control subsystem to said second mode.

8. A system for controlling vehicle moding according to claim 1, wherein said vehicle subsystem comprises a steering subsystem, a vehicle stability enhancement subsystem, a suspension subsystem, and a driveline subsystem; and
wherein after said controller determines an off-road driving condition and after said controller receives said second input from said input device said controller is further configured to change each of said steering subsystem, said vehicle stability enhancement subsystem, said suspension subsystem, and said driveline subsystem to said second mode.

9. A system for controlling vehicle moding according to claim 1, wherein said vehicle subsystem comprises a steering subsystem, a vehicle stability enhancement subsystem, a suspension subsystem, a driveline subsystem, and an electronic brake distribution subsystem; and
wherein after said controller determines a racetrack driving condition and after said controller receives said second input from said input device said controller is further configured to change each of said steering subsystem, said vehicle stability enhancement subsystem, said suspension subsystem, said driveline subsystem, and said electronic brake force distribution subsystem to said second mode.

10. A method for controlling vehicle moding in response to a driving condition, the method comprising the steps of:
determining the driving condition during operation of a vehicle subsystem;
operating the vehicle subsystem in a first mode upon receiving a first input indicating an acceptance of the first mode; and
operating the vehicle subsystem in a second mode based on one of receiving a second input and the driving condition, the second input indicating a non-acceptance of the first mode.

11. A method according to claim 10, wherein said determining step comprises determining at least one of a rain/snow condition, a tow/haul condition, a low-tire pressure/mini-spare present condition, a phone-in-use/multimedia-in-use condition, a nighttime condition, an off-road condition, and a racetrack condition.

12. A method according to claim 11 further comprising detecting a sport mode selection; and
wherein after determining the rain/snow condition and after receiving the second input said step of operating the vehicle subsystem in the second mode comprises:
changing a vehicle stability enhancement subsystem and a traction control subsystem to a normal mode; and
changing an adaptive cruise control subsystem to a comfort mode.

13. A method according to claim 11, wherein after determining the tow/haul condition and after receiving the first input said step of operating the vehicle subsystem in the first mode comprises changing each of a steering subsystem, a vehicle stability enhancement subsystem, a suspension subsystem, and a driveline subsystem to a tow/haul mode; and
wherein after determining the tow/haul condition and after receiving the second input said step of operating the vehicle subsystem in the second mode comprises changing a vehicle stability enhancement subsystem to the tow/haul mode.

14. A method according to claim 11, wherein after determining the low-tire pressure/mini-spare condition and after receiving the first input said step of operating the vehicle subsystem in the first mode comprises changing each of a steering subsystem, a vehicle stability enhancement subsystem, a suspension subsystem, and a driveline subsystem to a comfort mode; and
wherein after determining the low-tire pressure/mini-spare condition and after receiving the second input said step of operating the vehicle subsystem in the second mode comprises changing each of the steering subsystem, the vehicle stability enhancement subsystem, the suspension subsystem, and the driveline subsystem to the second mode.

15. A method according to claim 11, wherein after determining the phone-in-use/multimedia-in-use condition said step of operating the vehicle subsystem in the second mode comprises changing a vehicle stability enhancement subsystem to a comfort mode.

16. A method according to claim 11, wherein after determining the nighttime condition and after receiving the second input said step of operating the vehicle subsystem in the second mode comprises changing an adaptive cruise control subsystem to a comfort mode.

17. A method according to claim 11, wherein after determining the off-road condition and after receiving the first input said step of operating the vehicle subsystem in the first mode comprises changing each of a steering subsystem, a vehicle stability enhancement subsystem, a suspension subsystem, and a driveline subsystem to an off-road mode; and
wherein after determining the off-road condition and after receiving the second input said step of operating the vehicle subsystem in the second mode comprises changing the vehicle subsystem to a driver-selected mode.

18. A method according to claim 11, wherein after determining the race-track condition and after receiving the first input said step of operating the vehicle subsystem in the first mode comprises changing each of a steering subsystem, a vehicle stability enhancement subsystem, a suspension subsystem, a driveline subsystem, and an electronic brake force distribution subsystem to a sport mode; and
wherein after determining the race-track condition and after receiving the second input said step of operating the vehicle subsystem in the second mode comprises changing the electronic brake force distribution subsystem to the sport mode.

19. A control system for selecting an operation mode of a vehicle in response to a driving condition, the control system comprising:
an input device configured to receive first and second inputs, said first input indicating an acceptance of the operation mode, said second input indicating a non-acceptance of the operation mode;
a vehicle subsystem comprising at least two predetermined settings, said vehicle subsystem selected from an anti-lock braking subsystem, a traction control subsystem, a vehicle stability enhancement subsystem, an adaptive cruise control subsystem, a steering subsystem, a suspension subsystem, a driveline subsystem, and an electronic brake force distribution subsystem; and
a controller coupled to said vehicle subsystem and said input device, said controller configured to:
determine the driving condition;
change said vehicle subsystem to a first predetermined setting upon receiving said first input; and
change said vehicle subsystem to a second predetermined setting based at least in part upon receiving said second input and the driving condition.

20. A control system according to claim 19, wherein said traction control subsystem comprises a normal setting, a sport setting, a comfort setting, and a tow/haul setting;
wherein said steering subsystem comprises a tow/haul setting, a normal setting, a sport setting, a comfort setting, and an off-road setting;
wherein said anti-lock brake subsystem comprises a normal setting and an off-road setting;
wherein said driveline subsystem comprises a normal setting, a disable setting, a sport setting, and a comfort setting;
wherein said electronic brake force distribution subsystem comprises a normal setting and a sport setting;
wherein said adaptive cruise control comprises a normal setting and a comfort setting;
wherein said vehicle stability enhancement subsystem comprises a tow/haul setting, a normal setting, a sport setting, a comfort setting, and an off-road setting; and
wherein said suspension control subsystem comprises an off-road setting, a normal setting, a sport setting, a comfort setting, and a tow/haul setting.
